(19) United States
(12) Patent Application Publication
(10) Pub. No.: US 2025/0007223 A1
(43) Pub. Date: Jan. 2, 2025

(54) PLUG CONNECTOR HOUSING HAVING LOCKING PINS

(71) Applicant: HARTING ELECTRIC STIFTUNG & CO. KG, Espelkamp (DE)

(72) Inventors: Marc SCHLETH, Lemförde (DE); Martin SCHMIDT, Lübbecke (DE)

(21) Appl. No.: 18/707,063

(22) PCT Filed: Oct. 24, 2022
(86) PCT No.: PCT/DE2022/100784

§ 371 Date: May 2, 2024

(30) Foreign Application Priority Data
Nov. 3, 2021 (DE) 10 2021 128 633.6

(51) Int. Cl. H01R 13/73; H01R 13/631

(52) U.S. Cl. CPC H01R 13/73; H01R 13/631

(57) ABSTRACT

A plug connector housing is provided having at least two oppositely arranged locking pins projecting from the outside, wherein the plug connector housing has substructure elements, each being allocated to a respective locking pin. The substructure elements mechanically support the locking pins during the locking process. A plug connector including the plug connector housing is also provided.

### BACKGROUND

### Technical Field

The present disclosure relates to a plug connector housing and to a plug connector in which such a plug connector housing is used.

Plug connector housings are also referred to as grommet, socket or coupling housings, and are often composed of aluminum or an aluminum alloy, particularly when used in harsh industrial environments.

### Description of the Related Art

The document DE 20 2011 105 009 U1 shows a plug connector that can be assembled on an apparatus wall. Plug connectors of this type are also referred to as industrial plug connectors.

The plug connector housing shown herein has locking pins on which a U-shaped locking bracket can be pivotably mounted. Alternatively, the locking pins can also be used to engage across such a locking bracket. Such a plug connector is pluggable with a mating plug connector. The plug connector and mating plug connector can be locked to one another via the locking bracket. In the process, the locking bracket of the plug connector, in the locked state, engages across the locking pins disposed on the mating plug connector housing. As a result, the plug connectors, or their plug connector housings, are firmly pressed against one another.

Often, so-called riveting bolts are used as locking pins, whereby the plug connector housing and the riveting bolts are made of different materials. The plug connector housing is typically composed of a die-cast aluminum material, while the riveting bolt is usually composed of steel for stability reasons. Due to this material selection, undesirable contact corrosion occurs on the contact regions between the plug connector housing and the locking pins, or riveting bolts, respectively. This contact corrosion is particularly facilitated in harsh industrial environments.

The issue of contact corrosion is chemically tackled in the document EP 3 105 370 A1. The document EP 3 105 370 A1 shows a plug connector housing and/or an attachment housing having riveting bolts, or locking pins, mentioned above, respectively. The riveting bolts are provided with a metallic layer that reduces the contact corrosion between the housing material and the base material of the riveting bolts. Such chemical processes are complex and therefore render the plug connector housing more expensive. It has also been found that the chemical surface of the riveting bolts wears out over time due to mechanical stress during the locking process, and contact corrosion still occurs after a certain period of time.

A search by the German Patent and Trademark Office has found the following prior art in the priority application for the present application:
DE 10 2019 108 628 A1, DE 10 2017 119 057 B3, DE 10 2008 059 583 A1, DE 42 27 078 A1 and WO 2015/120 828 A1.

### BRIEF SUMMARY

Embodiments of the disclosure provide a reliable, cost-effective and durable plug connector housing.

An embodiment of a plug connector housing according to the present disclosure may be summarized as having at least two locking pins which project on the outside of the plug connector housing and are disposed so as to be mutually opposite. A locking bracket is able to be pivotably mounted on the locking pins. The locking pins can also equally be encompassed by such a locking bracket in order to lock the plug connection. As a result, depending on the situation, either a plug connector, for example equipped with an attachment housing which is screwed to a machine, or a mating plug connector, for example equipped with a grommet housing, can be equipped with the necessary locking bracket.

In some instances, the plug connector housing has a substantially rectangular cross section. Plug connectors embodied in this manner are also referred to as rectangular plug connectors or industrial plug connectors. In this instance, the long sides of the plug connector housing can in each case be equipped with two locking pins. In such a case, the plug connector housing would have a total of four locking pins. Such a plug connector housing could also be equipped with two locking brackets which are mounted on mutually opposite locking pins of the long sides and are pivotable over the narrow sides of the plug connector housing.

The plug connector housing described herein has substructure elements which are in each case assigned to a locking pin and provided for mechanically supporting the latter.

In some embodiments, the locking pins may be in each case designed as riveting bolts or threaded bolts. As a result, riveting bolts or threaded bolts can be composed of a material different from that of the plug connector housing.

Advantageously, the riveting bolts or threaded bolts are made of a non-metallic material, for example a plastics material or a ceramic material. Since the plug connector housing may be made of a metallic material, such as of aluminum or an aluminum alloy, contact corrosion in the fastening region of the riveting bolts or threaded bolts can be precluded by the use of non-metallic riveting bolts or threaded bolts.

In some embodiments, the substructure elements may be designed in the shape of a shell, resulting in a mechanically stable and load-bearing structure.

Advantageously, the substructure elements are integrally cast or molded on the outside of the plug connector housing. As a result, the plug connector housing can be equipped with substructure elements in a single operation. The manufacturing costs of plug connector housings of this type are not substantially increased as a result.

It is advantageous for the plug connector housing and the substructure elements to be composed of the same material. The integral molding process in a single operative step is thus enabled, or facilitated, as a result.

In some embodiments, the substructure elements may project substantially perpendicularly from the plug connector housing. As a result, the substructure elements can protrude from the plug connector housing in the same direction as the locking pins.

In at least some embodiments, the locking pins may in each case be surrounded by a sleeve. As a result, different materials can be used for the locking pin, or the riveting bolt or threaded bolt, respectively. In some embodiments, the sleeve may be composed of a metallic material which has low frictional wear in order to be able to guarantee many locking cycles. Alternatively, the sleeve may be composed of plastics material.

In some embodiments, the sleeve may be designed as a hollow cylinder with a circular cross section or as a hollow cylinder with a partially prismatic and partly circular cross section. In some embodiments, the shell-shaped substructure element may be modeled on the construction mode of the sleeve, so that the sleeve is supported on the substructure element in a form-fitting manner. As a result, a stable locking contour, or a stable locking region, can be formed.

### BRIEF DESCRIPTION OF THE SEVERAL VIEWS OF THE DRAWINGS

Embodiments of the disclosure are illustrated in the drawings and will be explained in more detail hereunder.

FIG. 1 shows a perspective illustration of a plug connector housing.

FIG. 2 shows an exploded illustration of a locking region of a first embodiment of the plug connector housing.

FIG. 3 shows an exploded illustration of a locking region of a second embodiment of the plug connector housing.

Some of the figures contain simplified schematic representations. To some extent, identical reference signs are used for elements that are similar but might not be identical. Different views of the same elements may be drawn to different scales. Directional indications such as “left,” “right,” “top” and “bottom” are to be understood with reference to the respective figure and in the individual representations may vary relative to the illustrated object.

### DETAILED DESCRIPTION

The present disclosure relates to a plug connector housing 1 having at least two locking pins 3, 3′, which project on the outside and are disposed so as to be mutually opposite, wherein the plug connector housing 1 has substructure elements 2, 2′ which are in each case assigned to a respective locking pin 3, 3′. The substructure elements 2, 2′ support the locking pins 3, 3′ mechanically during the locking procedure.

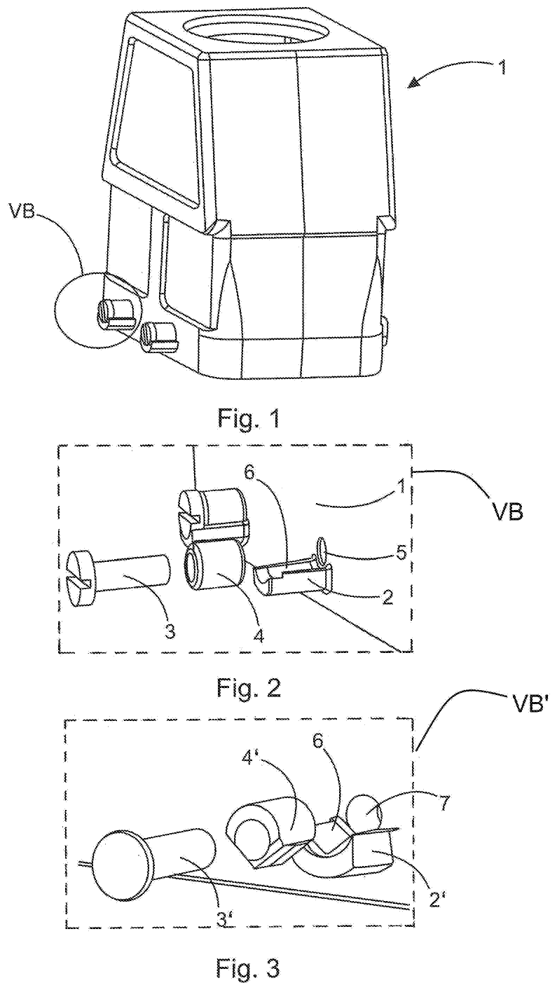

FIG. 1 shows a plug connector housing 1. The plug connector housing 1 has a substantially rectangular cross section, and in this embodiment is also referred to as a grommet housing by the person ordinarily skilled in the art. Corresponding attachment housings, which are attached as plug sockets to machines, are designed identically in terms of the aspects relevant to the disclosure and are therefore not illustrated separately.

Two locking regions VB, which are illustrated enlarged as corresponding exploded illustrations in FIGS. 2 and 3, are in each case illustrated on the respective long sides of the plug connector housing 1.

The connection regions VB are in each case composed of a substructure element 2, a locking pin 3, and a sleeve 4 pushed over the latter.

In the first embodiment shown in FIG. 2, the locking pin is illustrated as a threaded bolt 3 which can be screwed into a respectively provided threaded opening 5 of the plug connector housing 1, and can be fixed to the latter as a result. In this embodiment, the sleeve 4 disposed about the threaded bolt 3 has a circular cross section. The substructure element 2 has a matching partially cylindrical casing-shaped receptacle region 6. The substructure element 2 absorbs a large part of the force that engages on the locking pin 3 during the locking procedure. As a result, the locking pin 3 can even be made of a less stable material than before. Ideally, a material which does not enter into a chemical reaction with the material of the plug connector housing 1 is chosen for this purpose. The spacing between the materials in the electrochemical series should be as small as possible.

Illustrated in FIG. 3 is a second embodiment of the plug connector housing 1. In the plug connector housing 1 illustrated here, a riveting bolt 3′ is used as the locking pin. The riveting bolt 3′ is fixed in a rivet opening 7 provided for this purpose. The rivet opening 7 is advantageously designed as a through-opening. In the embodiment shown here, a sleeve 4′ pushed over the riveting bolt 3′ has a prismatic and partly circular cross section. The prismatic part is assigned to the substructure element 2′. The substructure element 2′ has a receptacle region with a corresponding cross section into which the prismatic region of the sleeve 4′ can be placed in a form-fitting manner. The partly circular cross section of the sleeve 4′ facilitates the locking procedure by allowing the receptacle region of the locking bracket (not shown) to slide over it. The substructure element 2′ absorbs most of the force that engages on the locking pin 3′ during the locking procedure. As a result, the locking pin 3′ can even be made of a less stable material than before. Ideally, a material which does not enter into a chemical reaction with the material of the plug connector housing 1 is chosen for this purpose.

In the embodiments shown here, the plug connector housings are made of die-cast aluminum material. The substructure element 2, 2′ is also in each case made of the same die-cast aluminum material. The riveting bolts or threaded bolts 3, 3′ are composed of plastics material or ceramic. Advantageously, the riveting bolts or threaded bolts 3, 3′ are of aluminum, as this is closest to the plug connector housing material in the electrochemical series and therefore does not cause contact corrosion. The sleeves 4, 4′ used in each case are composed of plastics material, a metal, for example steel, or a ceramic.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A plug connector housing, comprising:
at least two locking pins which project on an outside of the plug connector housing and are disposed so as to be mutually opposite; and
substructure elements which are in each case assigned to at least one respective locking pin.

2. The plug connector housing as claimed in claim 1, wherein the substructure elements are provided for relieving the mechanical load on the locking pins.

3. The plug connector housing as claimed in claim 1, wherein the locking pins are designed as riveting bolts or threaded bolts.

4. The plug connector housing as claimed in claim 1, wherein the substructure elements are integrally cast or molded on the outside of the plug connector housing.

5. The plug connector housing as claimed in claim 1, wherein the substructure elements are an integral constituent part of the plug connector housing.

6. The plug connector housing as claimed in claim 1, wherein the substructure elements project perpendicularly from the plug connector housing.

7. The plug connector housing as claimed in claim 1, further comprising at least two sleeves, and wherein the locking pins are in each case at least partially enclosed by a respective one of the sleeves.

8. The plug connector housing as claimed in claim 7, wherein each sleeve is designed as a hollow cylinder with a circular cross section or as a hollow cylinder with a partially prismatic and partly circular cross-section.

9. The plug connector housing as claimed in claim 7, wherein each of the substructure elements is designed in the shape of a shell to receive the respective sleeve in a form-fitting manner.

10. The plug connector housing as claimed in claim 7, wherein each sleeve is supported on the substructure element and is at least partially received therein in a form-fitting manner.

11. The plug connector housing as claimed in claim 1, wherein the plug connector housing and the locking pins are made of different materials.

12. The plug connector housing as claimed in claim 1, wherein the plug connector housing and the substructure elements are composed of the same material.

13. A plug connector, comprising:
a plug connector housing as claimed in claim 1.
